(19) United States
(12) Patent Application Publication
(10) Pub. No.: US 2008/0301242 A1
(43) Pub. Date: Dec. 4, 2008

(54) SYSTEM AND METHOD FOR PROTECTING CHAT CONTENT

(76) Inventors: RAJI L. AKELLA, Austin, TX (US); Scott J. Bennett, Round Rock, TX (US); Arif Kasim, San Antonio, TX (US); Sandy Kao, Austin, TX (US); Richard Slade, Austin, TX (US)

Correspondence Address: Greg Goshorn, P.C., 9600 Escarpment, Suite 745-9, AUSTIN, TX, 78749, US

(21) Appl. No.: 11/757,463

(22) Filed: Jun. 4, 2007

(51) Int. Cl. G06F 15/16; H04L 9/32

(52) U.S. Cl. 709/206; 726/3

(57) ABSTRACT

Provided is a method for ensuring the privacy of communication during a computer chat session. The claimed subject matter enables each participant of a chat session to choose whether or not to allow other participants to save, print or archive the text of the session. At the beginning of or during a chat session, a particular participant decides that the chat session should be private. The participant transmits a message indicating the desire to make the chat session private. Each participant receives a pop-up message that communicates the privacy request and is provided the option of accepting or declining the request. If a sufficient number of participants accept the request, programming logic that blocks any attempt to save the chat content to memory is executed with respect to the chat session. Different chat sessions may be configured with different options such as, but not limited to, inclusive and non-inclusive.

### TECHNICAL FIELD

The present invention relates generally to electronic communications and, more specifically, to a system and method for establishing an instant message chat session that cannot be stored, copied or printed.

### BACKGROUND OF THE INVENTION

Over the last several decades, computers have become a ubiquitous part of most households, almost as common as kitchen appliances. As computers have become more widely distributed, networks have been developed to connect computers together. Computers connected via a network can share resources such as printers, data storage and applications. Common types of networks include local area networks (LANs) and wide area networks (WANs). Over the past decade, the Internet has become a common medium for communicatively coupling computers. The Internet is a loosely coupled network of computers across the globe that enables an individual computer to exchange data and messages by means of an Internet protocol (IP). An IP address is typically associated with an established domain name. By using a domain name service (DNS) to translate a domain name into an IP address, people can communicate with other people on a different computer by primarily using domain names.

One development in the Internet and other networks is the instant chat message system, or a “chat.” A chat enables two or more participants to type comments into a computing system and have those comments posted both on the screen of the typist and almost simultaneously on the screen of the other participants of the chat. In this manner, participants are able to conduct a conversation although the participants may be distributed across the world. Unlike a typical conversation among people who are in geographical proximity to each other, messages associated with a chat are transmitted across the Internet or other network and may be stored in computer memories. A participant's comments may be saved, printed, transmitted to non-participants and reproduced. After a period of time, perhaps years, a comment typed in candor may come back to haunt the participant who made the comment.

What is needed is an instant message system that ensures the privacy of the participants. Such a system would enable a chat participant to specify that any comment made during a chat session could not be stored in computer memory, copied or printed by another participant, thus ensuring the privacy of the session.

### SUMMARY OF THE INVENTION

Provided is a method for ensuring the privacy of communication during a computer chat session. Unlike a typical computer chat session in which any participant may save a conversation to memory, print or transmit the content to a non-participant, the claimed subject matter enables each participant of a chat session to choose whether or not to allow other participants to save, print or archive the text of the session. In other words, a chat session may be declared private. In this way, a participant may be more inclined to give advice or opinions that the participant would otherwise might not feel free to give.

At the beginning of or during a chat session, a particular participant decides that the chat session should be private. The particular participant transmits a message indicating the desire to make the chat session private. Each participant receives a pop-up message that communicates the privacy request and is provided the option of accepting or declining the request. If a sufficient number of participants accept the request, programming logic that blocks any attempt to save the chat content to memory.

Different chat sessions may be configured with different options. One option is that any participant that requests a private chat session, or “P-chat,” may require that the session be “inclusive,” i.e. continued participation in the chat session is dependent upon agreement with the request. A “non-inclusive” session is one in which participants who do not agree to join are provided a separate, typical chat session. Another option is that if any participant does not agree to a privacy request, the initiator of the request is executed with respect to the chat session.

Different chat sessions may be configured with different options. One option is that any participant that requests a private chat session, or “P-chat,” may require that the session be “inclusive,” i.e. continued participation in the chat session is dependent upon agreement with the request. A “non-inclusive” session is one in which participants who do not agree to join are provided a separate, standard chat session. Another option is that if any participant does not agree to a privacy request, the initiator of the request may have the option of withdrawing the request. Another option is the ability to set limits on the establishment of a P-chat. For example, a participant may specify that all, a certain percentage or a minimum number of participants must agree to a P-chat before the P-chat is executed.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures.

FIG. 1 is an example of a computing system architecture that supports a private chat session, or “P-chat,” of the claimed subject matter.

FIG. 2 is a block diagram of a computer display showing a P-chat Request graphical user interface (GUI) for converting a chat session to a P-chat.

FIG. 3 is a block diagram of a computer display showing a P-chat Accept GUI for accepting or declining an invitation to convert a chat session to a P-chat.

FIG. 4 is a block diagram of a P-chat Notify GUI that notifies a participant of a chat session that the current session has become a P-chat.

FIG. 5 is a block diagram of a GUI that P-chat Terminate GUI notifies a participant of a chat session is terminated.

FIG. 6 is a flowchart of a Setup P-chat process that implements one aspect of the claimed subject matter.

FIG. 7 is a flowchart of an Accept/Decline (A/D) P-chat process that implements one aspect of the claimed subject matter.

FIG. 8 is a flowchart of a Transition to P-chat process that implements one aspect of the claimed subject matter.

### DETAILED DESCRIPTION OF THE FIGURES

Although described with particular reference to a computer chat session, the claimed subject matter can be implemented in any information technology (IT) system in which the privacy of communication is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for protected computer chat session, or “P-chat.” The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

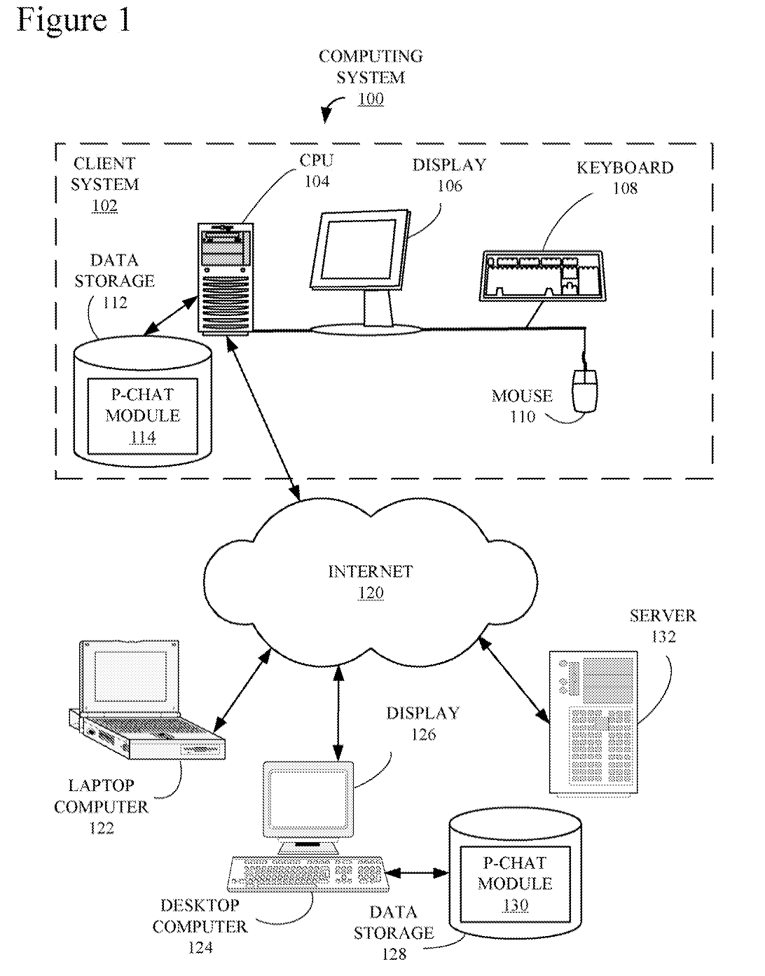

Turning now to the figures, FIG. 1 is a block diagram of an example of a computing system architecture 100 that incorporates the claimed subject matter. Computing system architecture 100 is only one example of a computing architecture that supports a private chat session, or “P-chat,” of the claimed subject matter.

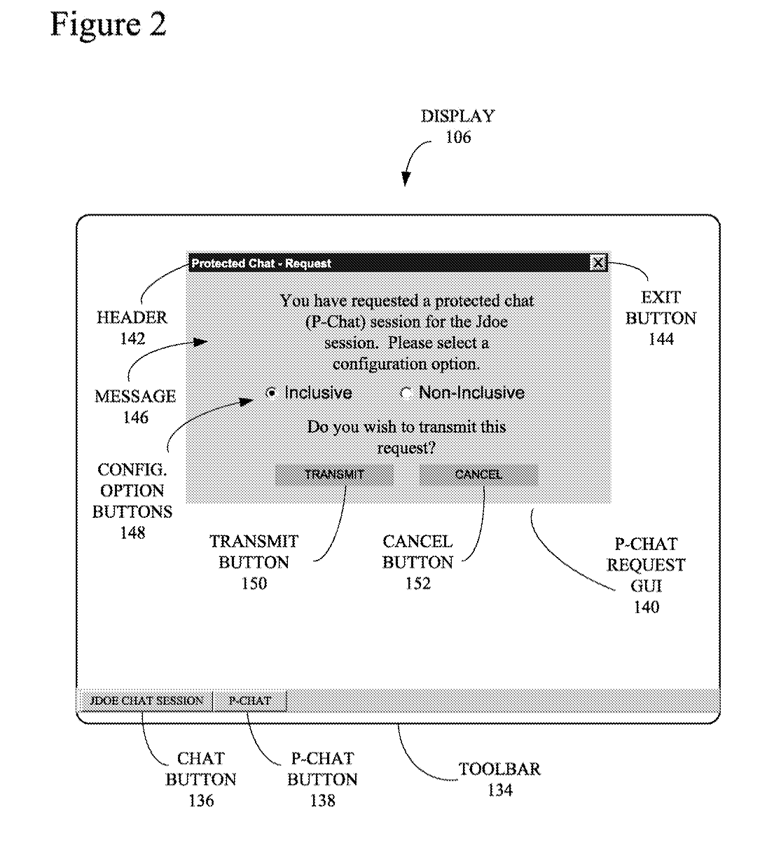

A client system 102 includes a central processing unit (CPU) 104, coupled to a display 106, a keyboard 108 and a mouse 110, which together facilitate human interaction with computing system 100 and client system 102. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing an example of a P-chat client module 114 that implements aspects of the claimed subject matter. It should be noted that a typical computing system would include more than one application, but for the sake of simplicity only one is shown. Module 114 is described in more detail below in conjunction with FIGS. 2-8.

Client system 102 and CPU 104 are connected to the Internet 120, which is also connected to a laptop computer 122, a desktop computer 124 and a server computer 132. In this example, desktop computer 124 also includes a display 126 and is coupled to a data storage 128, which stores a P-chat module 130. Module 130 is described in more detail below in conjunction with FIGS. 2-8. Although not necessarily illustrated, computers 122, 124 and 132 would also typically include components that provide the functionality of display 106, keyboard 108, mouse 110 and data storage 112. In this example, client system 102 and computers 122, 124 and 132 are communicatively coupled via the Internet 120, however they could also be coupled through any number of communication mediums such as, but not limited to, a local area network (LAN) (not shown). Further, it should be noted there are many possible computing system configurations, of which computing system 100 is only one simple example.

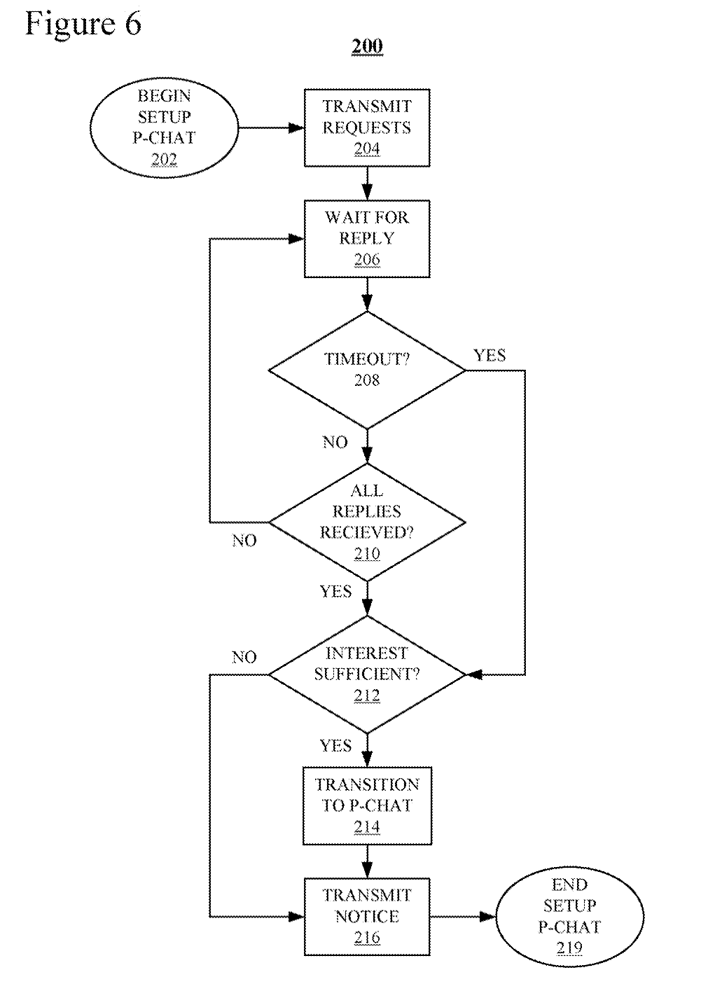

FIG. 2 is a block diagram of computer display 106 (FIG. 1) showing a typical Windows graphical user interface (GUI), which is published by the Microsoft Corporation of Redmond, Wash., with a toolbar 134. Included in toolbar 134 is a Jdoe chat session button 136 and an associated P-Chat button 138. Chat session button 136 is employed to access an ongoing chat session, which in this example is not shown on the screen. P-Chat button 138 is employed to initiate the conversion of the associated Jdoe chat session to a P-Chat. Once a conversion is initiated, a P-Chat Request GUI 140 is displayed on display 106. In this example, GUI 140 is generated by P-Chat module 114 (FIG. 1). The processing associated with the initiation of a P-Chat session is described in more detail below in conjunction with FIGS. 6-8. The use of a GUI such as the GUI 140 and the window associated with toolbar 134 and buttons 136 and 138 should be familiar to those with skill in the computing arts.

GUI 140 is initiated by a participant of a computer chat session, which in this example is entitled the “Jdoe session” and corresponds to chat button 136. The initiating participant generates GUI 140 by using mouse 110 (FIG. 1) to activate P-Chat button 138. GUI 140 includes a header 142, which merely states the name of GUI 140, i.e. “Protected Chat—Request,” and an Exit button 144, which enable the initiating participant to exit GUI 140 without executing a request to initiate a P-chat. A message section 146 informs the initiating participant of the purpose of GUI 140 and provides instructions on how to proceed. Configuration (config.) buttons 148 enable the initiating participant to select a particular type of P-chat session to initiate. Examples of configuration types illustrated in FIG. 2 are “Inclusive” and “Non-inclusive,” although there are many different possible configurations and a list (not shown) can be displayed to enable the initiating participant to describe possible configurations in more detail. Another possible configuration option may be a specification on particular limits to whether or not a P-chat is established. For example, an inviting participant may determine that all, a certain percentage or a minimum number of invited participants must indicate a willingness to participate in a particular P-chat for the P-chat to be established.

An inclusive P-chat is a chat session in which only participants that accept the request are permitted to remain in the session and those who do not agree to the request are terminated from the session. A non-inclusive chat session is one in which participants that agree to the request become participants of a private session in which the no copy, store and transmit rules of a P-chat apply, and the participants that do not agree to the request remain in the ongoing chat session. In alternative embodiment, an initiating participant may choose from a list (not shown) of participants to the ongoing chat session and specify those to whom the request should be transmitted.

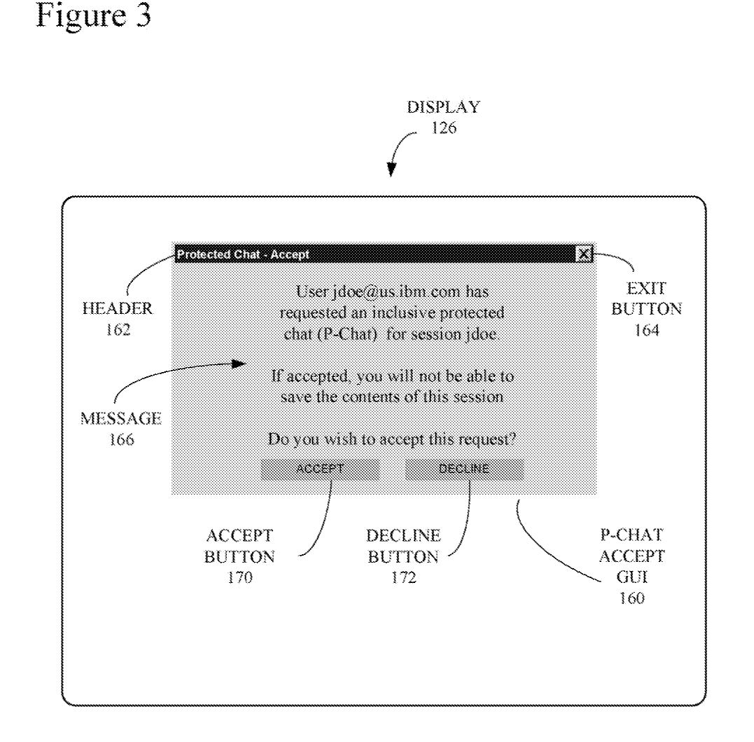

Finally, a Transmit button 150 and a Cancel button 152 are provided to enable the initiating participant to either send the P-chat request to either all other participants of the current session or selected members or to exit from GUI 140 without transmitting a request, respectively. The processing of a transmit request as well as other GUIs generated during the execution of the processing are described in more detail below, in conjunction with FIGS. 3-8.

FIG. 3 is a block diagram of computer display 126 (FIG. 1) showing a P-chat Accept GUI 160 for accepting or declining an invitation to convert a chat session to a P-chat. In this example, GUI 160 is generated by P-chat module 130 (FIG. 1) of computer 124 (FIG. 1) in response to the initiating participant's activation of Transmit button 150 (FIG. 2) of GUI 140 (FIG. 2). Like GUI 140, GUI 160 includes a header 162, which states the name of GUI 160, i.e. “Protected Chat—Accept,” and an Exit button 164, which enable the invited participant to exit GUI 160 without either accepting or declining the invitation. Typically, an exit from GUI 160 would generate a timeout in a Setup P-Chat process 200 (see FIG. 6) and be treaded as an indication that the invited participant is declining the request.

A message section 166 informs the invited participant that the designated participant has transmitted a request corresponding to the specified chat session and warns of the consequences of accepting the request, i.e. chat communications will not be able to be saved to memory for future use. Message section 166 also provides instructions on how to proceed with the acceptance or decline of a P-chat. An Accept button 170 enables the invited participant to accept the request and a Decline button 172 enables the participant to decline the request. A notification of the acceptance or decline of the request is transmitted to the inviting participant.

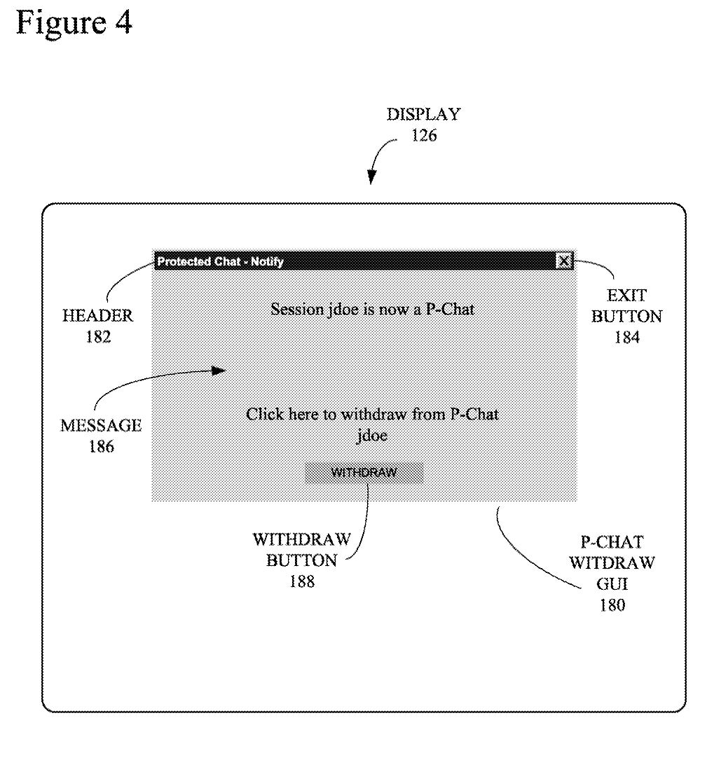

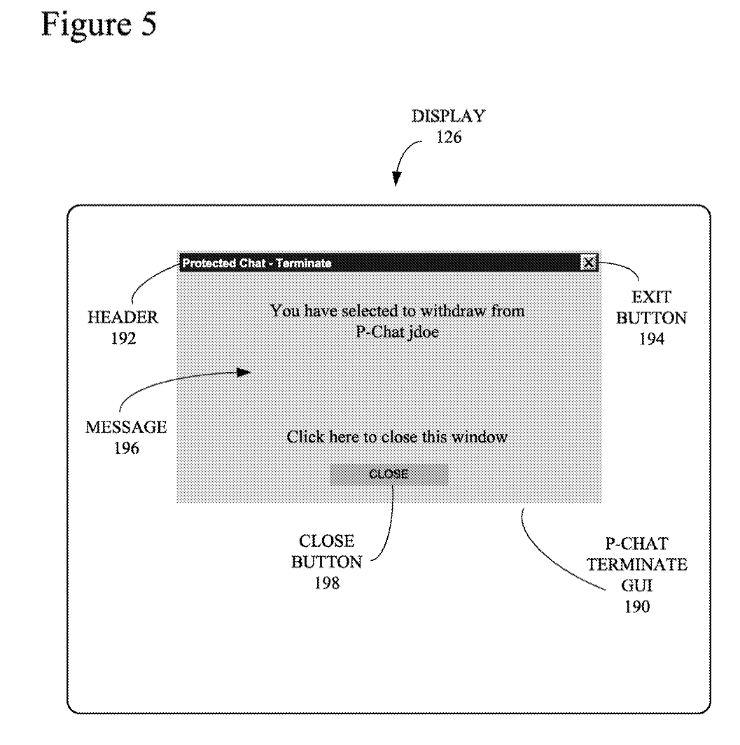

FIG. 4 is a block diagram of a P-chat Notify GUI 180, displayed on display 126 (FIG. 1), notifying a participant of a chat session that the current session has become a P-chat. In this example, GUI 180 is generated by P-Chat module 130 (FIG. 1) following the corresponding participant's acceptance of a P-chat by clicking on Accept button 170 (FIG. 3) of GUI 160 (FIG. 3), assuming that all other criteria for the acceptance of a particular P-chat have been satisfied. The process and setup of a particular P-chat are explained in more detail below in conjunction with FIGS. 5-8.

Like GUIs 140 and 160, GUI 180 includes a header 182, which states the name of GUI 160, i.e. “Protected Chat—Notify,” and an Exit button 184, which enable the invited participant to exit GUI 180. Typically, an exit from GUI 180 merely removes GUI 180 from display 126 without affecting the status of the underlying P-chat. A message section 186 informs the participant that the current chat session has been converted to a P-chat. In the event that the participant clicked on Decline button 172 (FIG. 3) of GUI 160, thus choosing not to participate in the P-chat, the displayed GUI would be a “Protected Chat—Decline” window (not shown) indicating the choice and specify the actions available to the participant. In the event of an inclusive P-chat, the participant's chat session would be terminated; in the case of a non-inclusive P-chat, the participant would be invited to resume the current chat session with all other participants that had also declined the invitation. Finally, a Withdraw button 188 enables the invited participant to withdraw from the P-chat. A notification of the withdrawal would be transmitted to all other participants

FIG. 5 is a block diagram of a GUI that P-chat Terminate GUI 190 notifies a participant that a particular P-chat is terminated. In this example, GUI 190, which is displayed on display 126 (FIG. 1), is generated by P-Chat module 130 (FIG. 1) following the corresponding participant's withdrawal from a ongoing P-chat by clicking on Withdraw button 188 (FIG. 4) of GUI 180 (FIG. 4).

Like GUIs 140, 160 and 180, GUI 180 includes a header 192, which states the name of GUI 160, i.e. “Protected Chat—Terminate,” and an Exit button 194, which enable the invited participant to exit GUI 190. Typically, an exit from GUI 190 merely removes GUI 190 from display 126 without affecting the status of the underlying P-chat. A message section 196 merely informs the participant of their decision to withdraw from the P-chat. Finally, a Close button 198 removes GUI 190 from display 126.

FIG. 6 is a flowchart of a Setup P-chat process 200 for initiating a P-chat. In this example, process 200 executes on CPU 104 (FIG. 1) of client system 102 (FIG. 1) in conjunction with P-chat module 114 (FIG. 1) although any participant may initiate a P-chat request. Process 200 is initiated when a participant elects to create a P-chat in conjunction with a standard chat session as explained above in conjunction with FIG. 1. In the following description, one participant, the initiating participant, is employing client system 102 and another participant, the receiving participant, is employing desktop computer 124. Of course, there could be more than two participants in any particular chat session, but for the sake of simplicity, the following description is limited to two participants, one on client system 102 and one on desktop computer 124 (FIG. 1).

Process 200 starts in a “Begin Setup P-chat” block 202 and proceeds immediately to a “Transmit Requests” block 204. During block 204, P-chat module 114 (FIG. 1) transmits a p-chat request via Internet 120 (FIG. 1) to p-chat module 130 (FIG. 1) executing on computer 124. The request is transmitted when the participant on client system 102 clicks on transmit button 150 (FIG. 2) of P-chat request GUI 140 (FIG. 2). As mentioned above, there may be more than two participants in a particular chat and, if so, a request is transmitted to each participant. In an alternative embodiment, the initiating participant selects other participants from a list and requests are only sent to the selected participants.

During a “Wait for Reply” block 206, P-chat module 130 sets a timer (not shown) and waits for replies to the request(s) transmitted during block 204. The value of the timer is set to a reasonable time period to enable each participant to reply. During a “Timeout?” block 208, process 200 has either received a reply that must be processed or the timer set during block 206 has expired. If a reply has been received rather than an expired timer, process 200 proceeds to an “All Replies Received?” block 210. During block 210, process 200 determines whether or not a reply has been received for each request transmitted during block 204. If not, process 200 proceeds to block 206 and processing continues as described above.

If, during block 210, process 200 determines that all requests have been responded to or, if during block 208, process 200 determines that the timer has expired, control proceeds to an “Interest Sufficient?” block 212. During block 212, process 200 determines whether or not either enough participants or required participants have indicated an acceptance of the proposed P-chat to continue with the establishment of the P-chat. As explained above in conjunction with FIG. 3, one configuration option associated with a P-chat request may be a requirement that all, a certain percentage or a minimum number of invited participants must indicate a willingness to participate in a particular P-chat for the P-chat to be established.

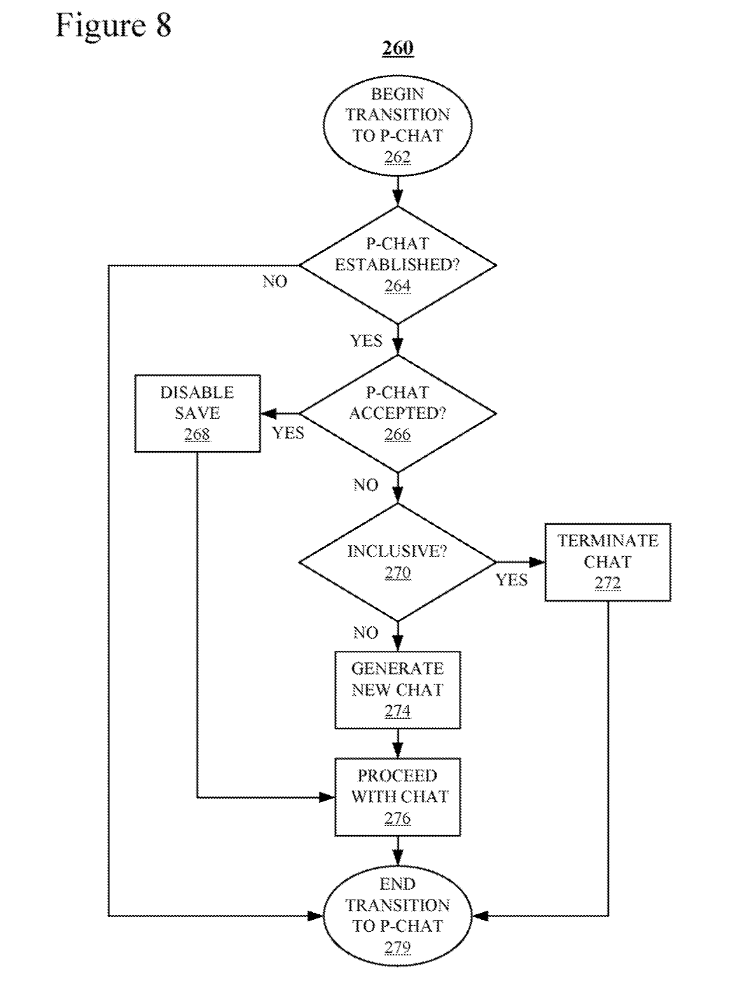

If process 200 determines to continue with the establishment of the P-chat, control proceeds to a “Transition To P-chat” block 214. During block 214, process 200 executes instruction necessary to establish a P-chat. The processing associated with block 214, with respect to both inviting and invited participants, is described in more detail below in conjunction with FIG. 8.

During a “Transmit Notice” block 216, P-chat module 114 transmits a message to each invited participant indicating the status of the P-chat request, i.e. either a notice that a P-chat session should be initiated or, if process 200 determined there was insufficient interest during block 212, a notice that a P-chat session should not be initiated. Finally, process 200 proceeds to an “End Setup P-chat” block 219 in which process 200 is complete.

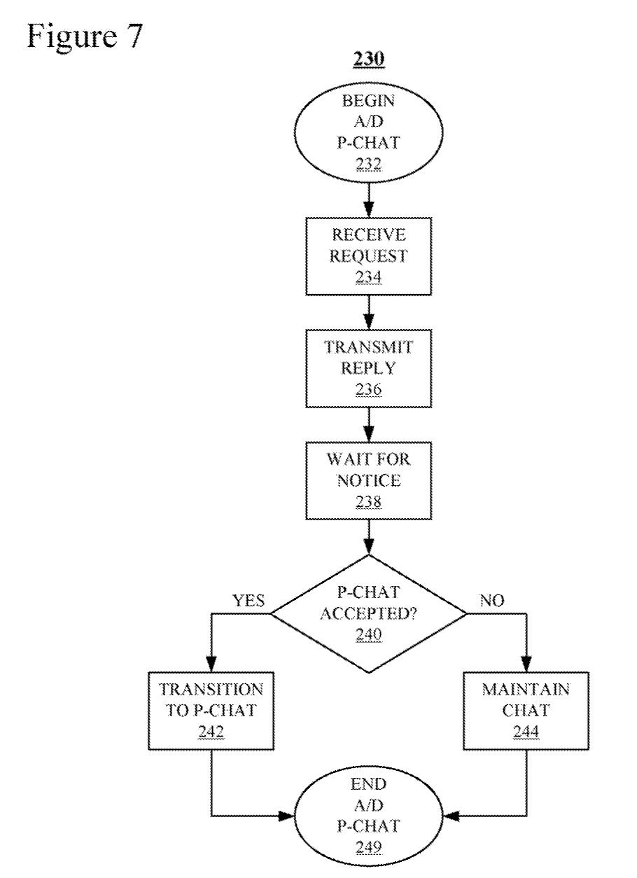

FIG. 7 is a flowchart of an Accept/Decline (A/D) P-chat process 230 for implementing one aspect of the claimed subject matter. Process 230 executes on each participant that receives a request for a P-chat as described above in conjunction with FIG. 6. In this example, the receiving participant is on desktop computer 124 (FIG. 1) and process 230 executes in conjunction with P-chat module 130 (FIG. 1).

Process 230 starts in a “Begin A/D P-chat” block 232 and proceeds immediately to a “Receive Request” block 234. During block 232, P-chat module 130 receives a P-chat request transmitted during block 204 (FIG. 6) of Setup P-chat process 200 (FIG. 6). The request takes the form of P-chat Accept GUI 160 (FIG. 3), which displays on display 126 notifying the receiving participant of the request and presenting the opportunity to accept or decline. During a “Transmit Reply” block 236, the participant indicates a selection by either clicking Accept button 170 (FIG. 3) or Decline button 172 (FIG. 3) on GUI 160. The reply is then transmitted to the inviting participant.

During a “Wait For Notice” block 238, the receiving participant may resume normal, non-P-chat activities while process 230 waits for further notification form the inviting participant. Once notice is received, process 230 proceeds to a “P-chat Accepted?” block 240. During block 240, process 230 determines whether or not the notice received in block 238 indicates that the p-chat session has been established. If so, process 230 proceeds to a “Transition to P-chat” block 242 during which the current, standard chat session is converted to a P-chat session. Processing, with respect to participants that have accepted an invitation and those who have declined, corresponding to block 242 is described in more detail below in conjunction with FIG. 8.

If process 230 determines during block 240 that a P-chat session has not been established, control proceeds to a “Maintain Chat” block 244 during which the chat session in effect at the beginning of process 230 remains active, without the features of a P-chat. Finally, following both block 242 and block 244, process 230 proceeds to an “End A/D P-chat” block 249 in which process 230 is complete.

FIG. 8 is a flowchart of a Transition to P-chat process 260 that implements one aspect of the claimed subject matter. Process 260 executes on the computer of each participant, which in this example are client system 102 (FIG. 1) and desktop computer 124 (FIG. 1) in conjunction with respective P-chat modules, or P-chat modules 114 and 130 (FIG. 1).

Process 260 starts in a “Begin Transition To P-chat” block 262 and proceeds immediately to a “P-chat Established?” block 264. During block 264, process 260 determines whether or not there was sufficient interest in a P-chat to establish the P-chat session. The information for this decision is included in the notice transmitted during block 216 (FIG. 6) and received during block 238 (FIG. 7). Of course, P-chat module 114 calculates this information directly rather than receiving the information in a notice. If the answer is “no,” process 260 proceeds to an “End Transition To P-chat” block 279 in which process 260 is complete.

If during block 264, process 260 determines that there was sufficient interest to establish a P-chat session, control proceeds to a “P-chat Accepted?” block 266. During block 264, P-chat module 130 determines whether or not the corresponding participant expressed an interest in joining the P-chat. Of course, P-chat module 114 would have chosen to do so or otherwise would probably not have transmitted a request in the first place. With respect to P-chat module 130, whether or not the invited participant accepted or declined the P-chat invitation depends upon whether the participant clicked on Accept button 170 (FIG. 3), Decline button 172 (FIG. 3) or Exit button 164 (FIG. 3) of GUI 160. If process 260 determines that transition to a P-chat should proceed, i.e. the P-chat was accepted, control proceeds to a “Disable Save” block 268. During block 268, P-chat modules 114 and 130 take steps to disable any functionality associated with saving the contents of the P-chat session to computer memory. Such steps may be associated with P-chat modules 114 and 130 and also may be associated with the operating system (OS) of the resident computer. Such steps may include, but are not limited to, the installation of interrupts corresponding to memory saves and screen dumps and the blocking of print drivers so that the contents of the P-chat may not be printed.

If during block 266, process 260 determines that the P-Chat was not accepted by the current invitee, control proceeds to an “Inclusive?” block 270. During block 270, process 260 determines whether or not the P-chat in the process of being established is configured as an inclusive P-chat. If so, process 260 proceeds to a “Terminate Chat” block 272 during which the current chat session with respect to the current invited participant is terminated so that the remaining participants may proceed with a P-chat.

If process 260, determines during block 270, that the P-chat being established is non-inclusive, control proceeds to a “Generate New Chat” block 274 during which a new, non-P-chat chat session is established for the benefit of those invited participants that elected not to participate in the P-chat. Once steps have been taken during block 268 to establish a P-chat or a new chat session has been established during 276, process 260 proceeds to a “Proceed With Chat” block 276. During block 276, each participant remaining in a chat session proceeds to their respective chats, i.e. P-chat participants to the established P-chat and invited participants who declined to the standard chat session established during block 274.

Finally, once the corresponding participant has either terminated their chat session during block 272 or entered a P-chat or another chat session during block 276, process 260 proceeds to an “End Transition To P-chat” block 279 in which process 260 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for configuring a computer chat session, comprising:
notifying each participant of a plurality of participants of a particular chat session that the chat session will transition to a private chat session;
implementing the private chat session by disabling the save and print functionality corresponding to the chat session for each participant.

2. The method of claim 1, further comprising:
receiving an answer from each participant indicating either an acceptance or a decline of the transition to a private chat session;
implementing the private chat session only for each participant that indicates an acceptance; and
terminating the chat session for each participant that indicates a decline.

3. The method of claim 2, further comprising:
setting a timeout value corresponding to an interval of time; and
interpreting an absence of an answer from a particular participant within the interval corresponding to the timeout value as a decline.

4. The method of claim 2, further comprising:
generating a new chat session; and
transitioning each participant that indicates a decline to the new chat session.

5. The method of claim 2, further comprising defining criteria for the implementation of the private chat session, wherein the implementation of the private chat session is contingent upon conformance with the criteria.

6. The method of claim 5, wherein the criteria is defined as a minimum number of acceptances.

7. The method of claim 5, wherein the criteria is defined as a ratio between the number of acceptances and the number of declines.

8. A system for implementing a computer chat session, comprising:
a processor;
logic, executing on the processor, for notifying each participant of a plurality of participants of a particular chat session that the chat session will transition to a private chat session;
logic, executing on the processor, for implementing the private chat session by disabling the save and print functionality corresponding to the chat session for each participant.

9. The system of claim 8, further comprising:
logic, executed on the processor, for receiving an answer from each participant indicating either an acceptance or a decline of the transition to a private chat session;
logic, executed on the processor, for implementing the private chat session only for each participant that indicates an acceptance; and
logic, executed on the processor, for terminating the chat session for each participant that indicates a decline.

10. The system of claim 9, further comprising:
a timeout value corresponding to an interval of time; and
logic, executed on the processor, for interpreting an absence of an answer from a particular participant within the interval corresponding to the timeout value as a decline.

11. The system of claim 9, further comprising:
logic, executed on the processor, for generating a new chat session; and
logic, executed on the processor, for transitioning each participant that indicates a decline to the new chat session.

12. The system of claim 9, further comprising defined criteria for the implementation of the private chat session, wherein the implementation of the private chat session is contingent upon conformance with the criteria.

13. The system of claim 12, wherein the defined criteria comprises a minimum number of acceptances.

14. The system of claim 12, wherein the defined criteria comprises a ratio between the number of acceptances and the number of declines.

15. A computer programming product for implementing a computer chat session, comprising:
a memory;
logic, stored on the memory, for notifying each participant of a plurality of participants of a particular chat session that the chat session will transition to a private chat session;
logic, stored on the memory, for implementing the private chat session by disabling the save and print functionality corresponding to the chat session for each participant.

16. The computer programming product of claim 15, further comprising:
logic, stored on the memory, for receiving an answer from each participant indicating either an acceptance or a decline of the transition to a private chat session;
logic, stored on the memory, for implementing the private chat session only for each participant that indicates an acceptance; and
logic, executed on the processor, for terminating the chat session for each participant that indicates a decline.

17. The computer programming product of claim 16, further comprising:
a timeout value corresponding to an interval of time; and
logic, stored on the memory, for interpreting an absence of an answer from a particular participant within the interval corresponding to the timeout value as a decline.

18. The computer programming product of claim 16, further comprising:
logic, stored on the memory, for generating a new chat session; and
logic, stored on the memory, for transitioning each participant that indicates a decline to the new chat session.

19. The computer programming product of claim 16, further comprising defined criteria for the implementation of the private chat session, wherein the implementation of the private chat session is contingent upon conformance with the criteria.

20. The computer programming product of claim 19, wherein the defined criteria comprises a minimum number of acceptances.
